(19) United States
(12) Patent Application Publication
(10) Pub. No.: US 2018/0176628 A1
(43) Pub. Date: Jun. 21, 2018

(54) INFORMATION DEVICE AND DISPLAY PROCESSING METHOD

(71) Applicant: SHARP KABUSHIKI KAISHA, Sakai City, Osaka (JP)

(72) Inventors: Takashi KANEKO, Sakai City (JP); Norio ITOH, Sakai City (JP); Masahiro SHIOI, Sakai City (JP)

(73) Assignee: Sharp Kabushiki Kaisha, Skai City, Osaka (JP)

(21) Appl. No.: 15/579,778

(22) PCT Filed: Jun. 17, 2016
(86) PCT No.: PCT/JP2016/068067

§ 371 Date: Dec. 5, 2017

(30) Foreign Application Priority Data
Jun. 30, 2015 (JP) 2015-132063

(51) Int. Cl. H04N 21/431; H04N 21/462; G09G 5/14; G09G 5/377

(52) U.S. Cl. CPC H04N 21/431; G09G 5/377; G09G 5/14; H04N 21/462

(57) ABSTRACT

With use of a PinP function, a display processing unit (230) of a display device (200) displays, while displaying a video of a baseball broadcasting program on a secondary screen positioned at a center part or its upper part of a primary screen, a different video, captured by a “camera including a wide-angle lens” that is installed behind the outfield of a baseball park as a broadcast spot, on the primary screen.

### TECHNICAL FIELD

The present invention relates to an information device having a function of combining and displaying a plurality of sets of content, and a system including such an information device.

### BACKGROUND ART

Various methods of combining and displaying main content and sub-content have been conventionally proposed.

For example, PTL 1 indicates a method for displaying composite content constituted by a main text (main content) and a video, an image, sound, and the like (sub-content) that support the main text. In addition, for example, PTL 2 indicates a method for displaying a video of a certain program (main content) on a main screen and displaying a video of another program (sub-content) on a sub-screen that is arranged in a lower part of the main screen.

### CITATION LIST

### Patent Literature

PTL 1: International Publication No. 2012/066748 (published on May 24, 2012)

PTL 2: Japanese Patent No. 4765462 (issued on Sep. 7, 2011)

### SUMMARY OF INVENTION

### Technical Problem

In recent years, there has been a television receiver capable of, while displaying a video of a broadcast program in a certain area, displaying a browser screen in another area.

As a recent mobile terminal has a significantly enhanced communication function compared to an old mobile terminal, use of the recent mobile terminal allows a user to distribute a moving image in a live streaming manner through a moving image distribution site from an outside location.

Thus, in a case where a person in the seat of a baseball park (a broadcast spot for baseball broadcasting) distributes a moving image in a live streaming manner, for example, a viewer is able to watch the moving image registered in a moving image distribution site while viewing a baseball broadcasting program with use of the television receiver.

However, even when the viewer watches the moving image distributed by the person in the seat of the baseball park while viewing the baseball broadcasting program with use of the television receiver, it is difficult for the viewer to experience realistic sensation as if he or she was actually in the seat.

The invention was made in view of the aforementioned problems, and a main object thereof is to realize an information device that causes a viewer to view a broadcasting program while giving realistic sensation as if the viewer was actually in a broadcast spot.

### Solution to Problem

In order to solve the aforementioned problems, an information device according to an aspect of the invention includes an acquisition processing unit that individually acquires a video of a broadcasting program and a different video in a lower part of which spectators in a broadcast spot appear; and a display processing unit that displays, while displaying the different video on a primary screen, the video of the broadcasting program on a secondary screen with use of a picture-in-picture function, in which the different video is a video generated by a camera in the broadcast spot, and the secondary screen is positioned at a center part or an upper part thereof of the primary screen.

### Advantageous Effects of Invention

An information device according to an aspect of the invention exerts an effect of allowing a viewer to view a broadcasting program while giving realistic sensation as if the viewer was actually in a broadcast spot.

### BRIEF DESCRIPTION OF DRAWINGS

FIG. 1 is a block diagram of devices of a VOD server, a camera, and a display device that constitute a system according to Embodiment 1 of the invention.

FIG. 2 illustrates a place where a camera according to each of Embodiments 1 and 2 of the invention is installed.

FIG. 3 is a flowchart illustrating an initial operation of the display device according to each of Embodiments 1 and 2 after an operation of reproducing a broadcasting program is received.

FIG. 4 exemplifies a video displayed by the display device according to each of Embodiments 1 and 2 in which the initial operation has finished.

FIG. 5 is a view for explaining that “a sense of togetherness for cheering” given to both a cheerer who is visiting the spot (baseball park) for baseball broadcasting and a cheerer for the same team who is not visiting the baseball park is enhanced by a system according to each of Embodiments 1 and 2.

FIG. 6 is another view for explaining that “a sense of togetherness for cheering” given to both a cheerer who is visiting the baseball park and a cheerer for the same team who is not visiting the baseball park is enhanced by the system according to each of Embodiments 1 and 2.

FIG. 7 is a block diagram of devices of a broadcasting device, a camera, and a display device that constitute the system according to Embodiment 2 of the invention.

### DESCRIPTION OF EMBODIMENTS

### Embodiment 1

Hereinafter, devices of a VOD server, a display device, and a camera that are included in a system according to an embodiment of the invention will be described in detail with reference to the drawings.

### (Outlines and Configurations of Devices)

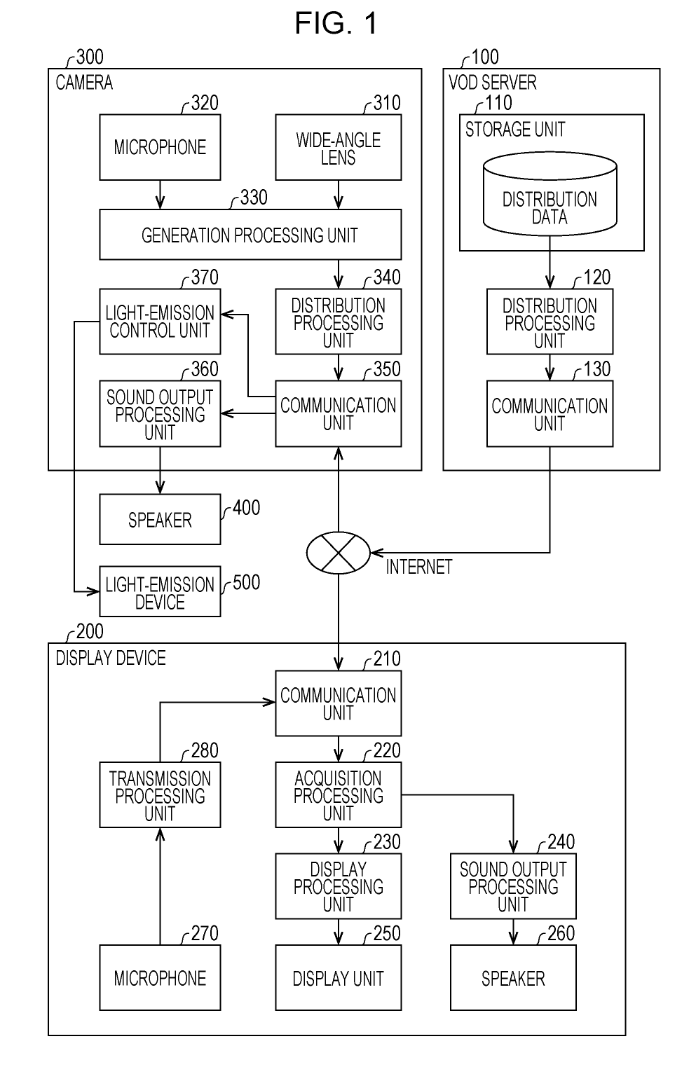

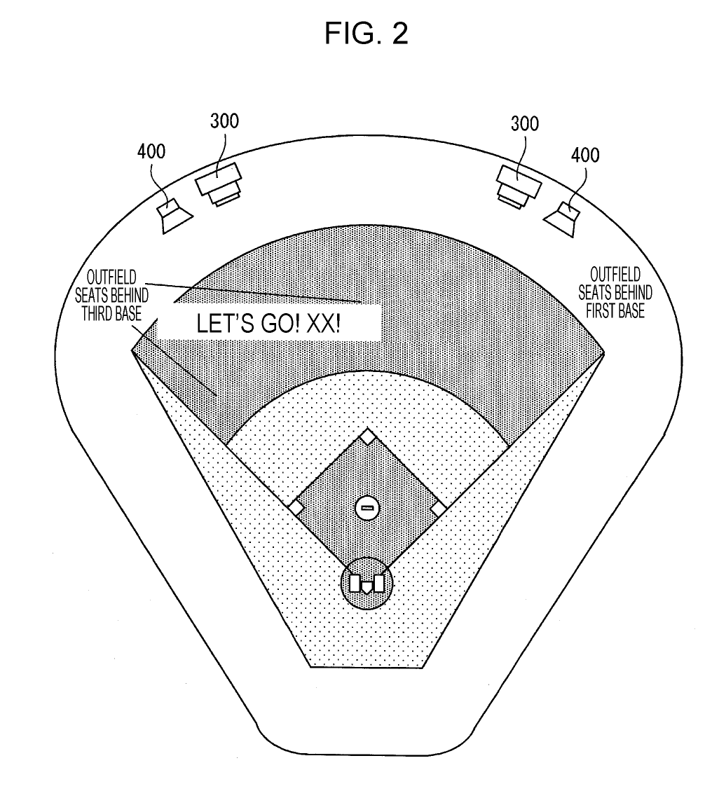

Outlines and configurations of main devices included in the system will be described with reference to FIGS. 1 and 2. FIG. 1 is a block diagram illustrating a configuration of a main part of each of the main devices included in the system. FIG. 2 illustrates a place where a camera is installed.

As illustrated in FIG. 1, the system according to the present embodiment is a system that includes a VOD server 100, a display device 200, and a camera 300.

The VOD server 100 is a server that distributes distribution data indicating content of a broadcasting program (a baseball broadcasting program in the present embodiment) (that is, indicating a video and sound of the broadcasting program).

The display device 200 is a device that receives the distribution data indicating the video and the sound of the broadcasting program via the Internet and reproduces the broadcasting program.

The camera 300 is a camera (wide-angle camera) that includes a wide-angle lens 310 and a microphone 320. As illustrated in FIG. 2, the camera 300 is installed behind the outfield (on a pole provided behind the outfield seats in the present embodiment) in the spot for baseball broadcasting (baseball park).

That is, the camera 300 captures a video indicating an almost entire state of an area formed by the seats and a playing field of the baseball park, and collects sound of cheering of spectators in the outfield seats.

### (VOD Server 100)

As illustrated in FIG. 1, the VOD server 100 includes a storage unit 110, a distribution processing unit 120, and a communication unit 130.

The storage unit 110 is a recording medium (for example, Hard Disc Drive) in which distribution data is recorded.

The distribution processing unit 120 distributes the distribution data via the communication unit 130. The distribution processing unit 120 may be realized by a CPU.

The communication unit 130 is a communication interface (for example, an Ethernet (registered trademark) interface) supporting IP communication.

### (Display Device 200)

As illustrated in FIG. 1, the display device 200 includes a communication unit 210, an acquisition processing unit 220, a display processing unit 230, a sound output processing unit 240, a display unit 250, a speaker 260, a microphone 270, and a transmission processing unit 280.

The communication unit 210 is a communication interface (for example, an Ethernet interface) supporting IP communication.

The acquisition processing unit 220 individually acquires, via the Internet, a video of the broadcasting program and a different video (that is, a video in a lower part of which cheering spectators in the outfield seats appear and in a center part or its upper part of which two matching teams to which attention of the spectators is paid appear) which is captured (generated) by the camera 300.

That is, the acquisition processing unit 220 receives the distribution data that includes URL information (acquisition destination information indicating an acquisition destination of the different video) and video data and sound data of the broadcasting program, and thereby acquires the video of the broadcasting program together with the URL information. The acquisition processing unit 220 is connected to the camera 300 as the acquisition destination of the different video by referring to the URL information included in the distribution data and acquires the different video from the camera 300.

With use of a picture-in-picture function, the display processing unit 230 displays, while displaying the different video on a primary screen, the video of the broadcasting program on a secondary screen positioned at a center part or its upper part of the primary screen. That is, the display processing unit 230 displays a part of the different video and the video of the broadcasting program in a display area of the display unit 250 by using the picture-in-picture function.

In other words, the display processing unit 230 performs display so that the video of the broadcasting program is superimposed on the different video in such a manner that a viewer is able to visually recognize an image in a remaining area other than a specific area (a center or its upper area) of the different video. In the present embodiment, the image in the specific area is an image of the playing field with the “two matching teams” that do not appear clearly because of being away from the camera 300 and the image in the remaining area is an image of many spectators visiting the ball park.

While outputting the sound of the broadcasting program from the speaker 260, the sound output processing unit 240 outputs, from the speaker 260, the sound which is collected by the camera 300.

The display unit 250, the speaker 260, and the microphone 270 are respectively general known display, speaker, and microphone.

While the acquisition processing unit 220 is acquiring the video from the camera 300, the transmission processing unit 280 transmits, to the camera 300, sound data indicating sound of cheering of the viewer that is collected (captured) by the microphone 270.

Note that, the acquisition processing unit 220, the display processing unit 230, the sound output processing unit 240, and the transmission processing unit 280 may be realized by a CPU.

### (Camera 300)

As illustrated in FIG. 1, the camera 300 includes the wide-angle lens 310, the microphone 320, a generation processing unit 330, a distribution processing unit 340, a communication unit 350, a sound output processing unit 360, and a light-emission control unit 370.

The wide-angle lens 310 and the microphone 320 are respectively general known lens and microphone.

The generation processing unit 330 generates data of a video which indicates a scene (the almost entire state of the area formed by the seats and the playing field of the baseball park) captured by the wide-angle lens 310 and which has sound (sound of cheering in the outfield seats) collected (captured) by the microphone 320.

The distribution processing unit 340 distributes, to the display device 200 connected to the camera 300, the video data with the sound, which is generated by the generation processing unit 330, via the communication unit 350.

The communication unit 350 is a communication interface (for example, an Ethernet interface) supporting IP communication.

The sound output processing unit 360 outputs, from an external speaker 400, sound indicated by the sound data transmitted by the transmission processing unit 280 to the camera 300.

Every time a fixed time period has lapsed, the light-emission control unit 370 specifies a total sum of data (an indicator indicating vigorousness of cheering of the viewer in the fixed time period) of the sound data received by the camera 300 from one or more display devices 200 in the fixed time period.

The light-emission control unit 370 controls an external light-emission device 500 so that every time a total sum of data is specified, a light-emission operation in a form according to the total sum of data is performed in a next fixed time period. For example, the light-emission control unit 370 controls the light-emission operation of the light-emission device 500 so that light-emission intensity increases as the total sum of data increases.

Note that, the generation processing unit 330, the distribution processing unit 340, the sound output processing unit 360, and the light-emission control unit 370 may be realized by a CPU.

As above, the outlines and the configurations of the VOD server 100, the display device 200, and the camera 300 that are the main devices included in the system have been described.

Note that, the speaker 400 and the light-emission device 500 are respectively known general speaker and LED light-emission device.

### (Operation of Display Device 200)

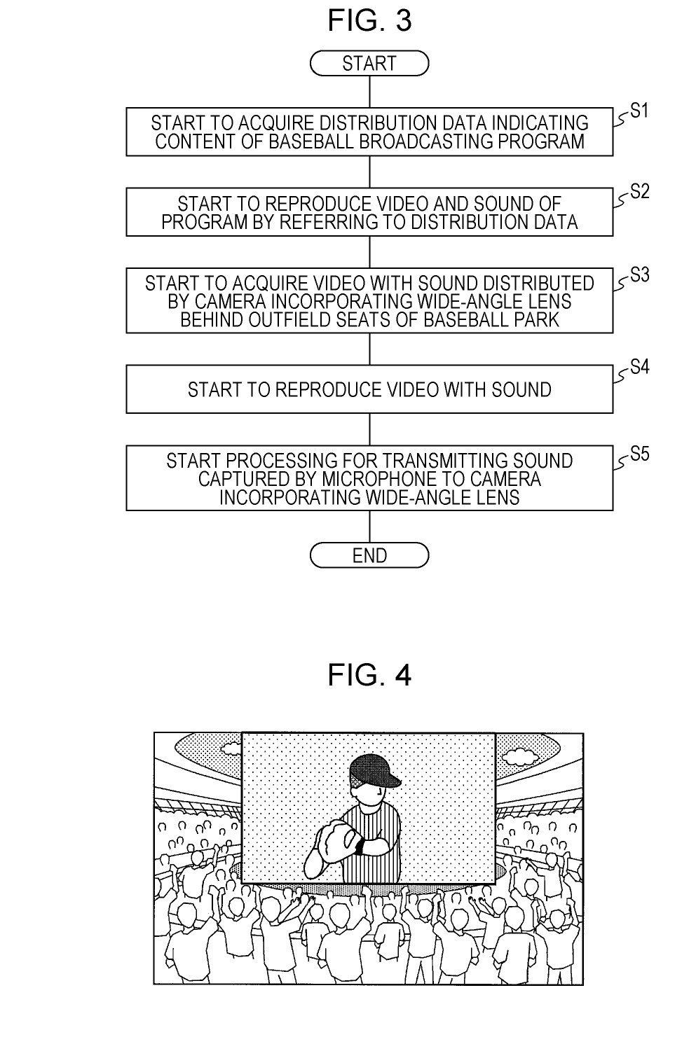

Next, an operation of the display device 200 after an operation of reproducing the baseball broadcasting program is received will be described with further reference to FIGS. 3 to 6.

FIG. 3 is a flowchart illustrating an initial operation of the display device 200 after the aforementioned operation is received. FIG. 4 exemplifies a video displayed by the display device 200 in which the initial operation has finished.

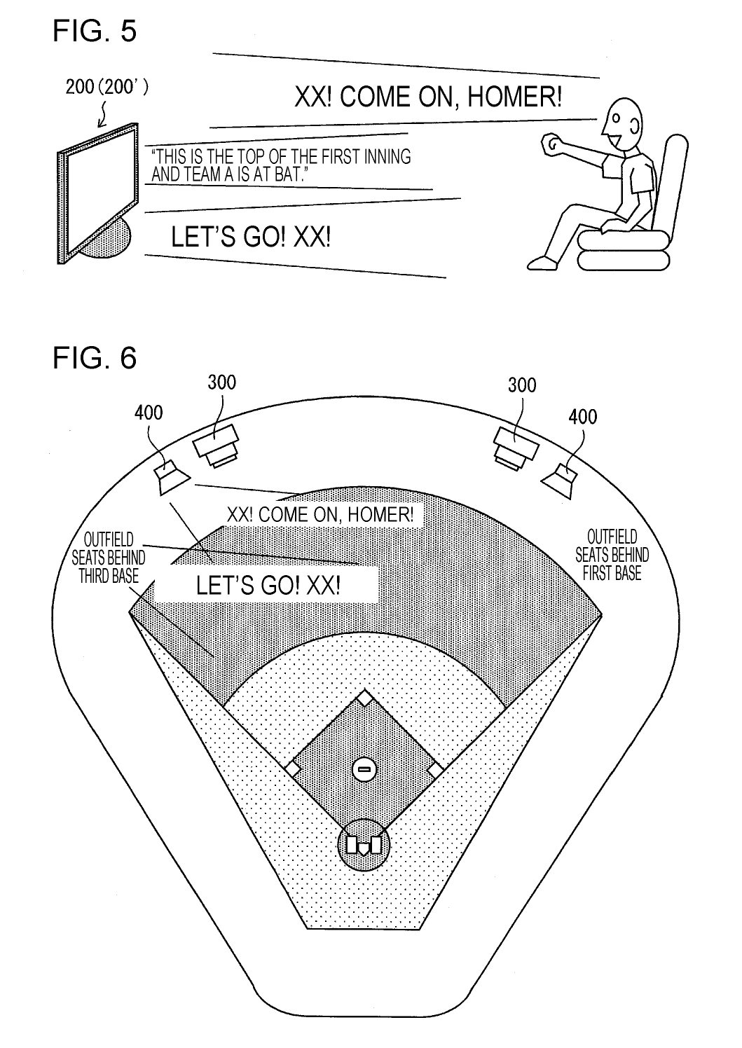

FIGS. 5 and 6 are views for explaining that “a sense of togetherness for cheering” given to both a cheerer who is visiting the baseball park and a cheerer for the same team who is not visiting the baseball park is enhanced by the system according to the present embodiment.

The acquisition processing unit 220 of the display device 200 that has received the aforementioned operation starts to acquire distribution data indicating content of the baseball broadcasting program at S1 as illustrated in FIG. 3.

Specifically, the acquisition processing unit 220 requests the VOD server 100 to distribute the distribution data of baseball broadcasting and starts to acquire the distribution data that is transmitted to the display device 200 by the VOD server 100 having received the request.

The distribution data includes a pair of URL information indicating an acquisition destination of a video generated by “the camera 300 near the outfield seats behind the first base” illustrated in FIG. 2 and information indicating an installation place (near the outfield seats behind the first base) of the camera 300. Similarly, the distribution data includes a pair of URL information indicating an acquisition destination of a video generated by “the camera 300 near the outfield seats behind the third base” illustrated in FIG. 2 and information indicating an installation place (near the outfield seats behind the third base) of the camera 300.

After S1, the display processing unit 230 and the sound output processing unit 240 respectively start to reproduce a video and sound of the baseball broadcasting program by referring to the distribution data acquired by the acquisition processing unit 220 (S2). Specifically, the display processing unit 230 displays the video of the baseball broadcasting program on a secondary screen and thereby causes the video of the baseball broadcasting program to be displayed in a specific area (a center part or its upper part of a display area) in the display area, and the sound output processing unit 240 outputs the sound of the baseball broadcasting program from the speaker 260.

Further, the display processing unit 230 refers to the information indicating the installation places of the two cameras 300 and displays, in a lower part of the display area, a UI button which indicates the installation place of one of the cameras 300 and a UI button which indicates the installation place of the other camera 300.

When the viewer presses any UI button (normally, a UI button corresponding to the outfield seats with spectators cheering a team that the viewer likes), the acquisition processing unit 220 starts to acquire a video with sound that is distributed by the camera 300 corresponding to the pressed UI button (S3).

Specifically, the acquisition processing unit 220 refers to URL information that is paired with the information indicating the installation place corresponding to the pressed UI button and accesses a URL indicated by the URL information, and thereby requests the camera 300 to distribute the video with sound. The acquisition processing unit 220 starts to acquire the video with sound that is transmitted to the display device 200 by the camera 300 having received the request.

After S3, the display processing unit 230 and the sound output processing unit 240 respectively start to reproduce the video and the sound acquired by the acquisition processing unit 220 (S4). Specifically, the display processing unit 230 displays the video generated by the camera 300 on a primary screen and thereby displays a part of the video in a remaining area of a display area, and the sound output processing unit 240 outputs, from the speaker 260, the sound collected by the camera 300.

More specifically, the sound output processing unit 240 performs the following processing (processing which is not essential in the invention) specific to the present embodiment. That is, the sound output processing unit 240 outputs the sound collected by the camera 300 so that an average output level of the sound (sound indicating cheering sound of the spectators) collected by the camera 300 is larger than an average output level of sound of the program (sound of live broadcasting by an announcer).

As a result, content displayed in the display area is, for example, the content as illustrated in FIG. 4. Moreover, the viewer is able to listen to the sound (sound indicating the cheering sound of the spectators) collected by the camera 300 with large volume as illustrated in FIG. 5.

Thus, even when the viewer is in his or her home, the viewer is able to view the broadcasting program while experiencing realistic sensation as if he or she was cheering in the baseball park with the spectators cheering the team that he or she likes.

After S4, the transmission processing unit 280 performs a step of S5 (a step which is not essential in the invention) specific to the present embodiment. That is, the transmission processing unit 280 starts processing for transmitting, to the camera 300 connected to the display device 200, the sound data indicating the sound collected by the microphone 270.

As a result, the transmission processing unit 280 transmits, to the camera 300, the sound data indicating the cheering sound of the viewer as illustrated in FIG. 5. Then, in the camera 300 having received the sound data, the sound output processing unit 360 outputs the cheering sound of the viewer from the speaker 400 as illustrated in FIG. 6.

Thereby, a spectator near the speaker 400 feels as if he or she was cheering with a sense of togetherness with “the viewer who is cheering the same team that the spectator likes and is not visiting the baseball park”.

Note that, the sound output processing unit 360 may perform the following processing for each fixed time period while the camera 300 is connected to many display devices 200.

That is, when a fixed time period starts, the sound output processing unit 360 may select a part (for example, one display device 200) of the display devices 200 from among the many display devices 200 in accordance with any criterion (for example, at random). Then, in the fixed time period, the sound output processing unit 360 may output, from the speaker 400, only sound indicated by sound data transmitted by the selected part of the display devices 200.

### (Other Advantages of System)

The system according to the present embodiment also has the following advantages.

With use of the camera 300 including the wide-angle lens, a distributer of the program is able to inform, through a video, the viewer of a state (a state of spectators who are in a visual field when the viewer actually sits on the outfield seat) of many spectators in the ball park.

As a program video with a relatively large size is displayed in a center part or its upper part of a display area, it is easy for the viewer to grasp a state of a player or a proceeding state of a game.

Since it appears as if many spectators appearing in a lower part of the display area were cheering while watching the program video, “a sense of togetherness for cheering with the many spectators” that the viewer feels increases.

Note that, because of display of the program video, the viewer is not able to visually recognize a part of the video distributed by the camera 300. Specifically, the viewer is not able to visually recognize an image (an image of the playing field with the two matching teams) appearing in a center part or its upper part of the video distributed by the camera 300.

However, in view of that “as the camera 300 includes the wide-angle lens, it is not possible to sufficiently recognize the state of the player or the proceeding state of the game even when the part of the video is seen”, it may be said that it is not a particular problem for the viewer that the part of the video is not able to be visually recognized.

Note that, in the system, the display device 200 is set to display a program video and a video distributed by the camera 300 so that a clear boundary between the program video and the video distributed by the camera 300 is visually recognized (so that they are separated with the boundary of straight line). However, the invention is not limited to such a configuration.

That is, the display device 200 may transparently display the program video in the secondary screen. For example, the display device 200 may transparently display the program video so that a transmittance of a pixel whose distance from a center of the program video is relatively long is relatively high.

This makes it possible for the viewer to view the broadcasting program while more strongly feeling realistic sensation as if he or she was actually in the broadcast spot.

The display deice 200 may have an image that represents a large display device (centerfield screen) or a screen for a projector held inside thereof in advance. The display device 200 may perform display so that the image representing the screen is superimposed on the video of the broadcasting program instead of directly displaying the video of the broadcasting program on the secondary screen. Specifically, the display device 200 may transparently display the image representing the screen so that a transmittance of a peripheral portion is 0% and a transmittance of a center part is 100% (that is, so that the viewer is able to visually recognize only an outer edge portion of the screen).

This makes it possible for the viewer to feel as if he or she actually viewed the program video displayed on the centerfield screen with a sense of togetherness with the spectators in the baseball park.

Note that, in the system, the display processing unit 230 is set to perform display so that the video of the broadcasting program is superimposed on the video from the camera 300 by using the picture-in-picture function, but the invention is not limited to such a configuration.

For example, a server (not illustrated) that acquires the video of the broadcasting program distributed by the VOD server 100 and the video from the camera 300 and that generates a combined video by overlapping the video of the broadcasting program on the video from the camera 300 may be additionally provided.

In this case, the display device 200 may acquire, from the VOD server 100, distribution data in which URL information indicating an acquisition destination of the combined video is included, acquire the combined video from the acquisition destination (the server that is additionally provided) indicated by the URL information, and display the combined video thus acquired.

### (Additional Matter 1)

The display device 200 may have a mode of displaying the video distributed by the camera 300 and a mode of not displaying the video distributed by the camera 300.

In this case, the display device 200 may perform the operation according to the flowchart of FIG. 3 only when the display device 200 is set to the mode of displaying the video distributed by the camera 300. In other words, the display device 200 may perform only S1 and S2 in the flowchart of FIG. 3 (perform full-screen display of the program video at S2) when the display device 200 is set to the mode of not displaying the video distributed by the camera 300.

### (Additional Matter 2)

The system according to Embodiment 1 may include, instead of the three devices (the camera 300, the speaker 400, and the light-emission device 500), one device (site device) that has the function of the camera 300, the function of the speaker 400, and the function of the light-emission device 500.

The camera 300 may be an omnidirectional camera or a camera of another type (such as a super wide-angle camera or a fish-eye camera) including a lens (for example, such as a super wide-angle lens or a fish-eye lens) having a wider angle of view (a shorter focal distance) than that of a standard lens.

Alternatively, N (N: plural number) cameras which are not wide-angle cameras may be used instead of the camera 300. In this case, the display device 200 may display videos from the cameras in respective N rectangular areas other than one rectangular area (non-display area) hidden by the secondary screen among N+1 rectangular areas forming the primary screen.

When five cameras are used instead of the camera 300, for example, the display device 200 may display a video as illustrated in FIG. 4 by displaying corresponding videos from the cameras in five rectangular areas (a rectangular area positioned on the left side of the non-display area, a rectangular area positioned on the lower left of the non-display area, a rectangular area positioned right under the non-display area, a rectangular area positioned in the lower right of the non-display area, and a rectangular area positioned on the left side of the non-display area).

Also when the display device 200 configured as described is used, the viewer is able to view the broadcasting program while feeling realistic sensation as if he or she was actually in the broadcast spot.

Note that, needless to say, the five cameras need to be placed at appropriate positions to be directed in appropriate directions in order to allow the display device 200 to display the video as illustrated in FIG. 4.

Each of the cameras may have at least a function, such as a GPS, of acquiring position information and a function, such as a triaxial magnetometer, of acquiring direction information. Each of the cameras may be configured to move until reaching an appropriate position while checking position information of the camera and further adjust a direction of the camera to an appropriate direction in accordance with an instruction from a terminal (not illustrated) that is separately provided.

Note that, a person who installs the cameras is able to gasp which part of the entire ball park is included in an imaging range of each of the cameras on the basis of a current position and direction of the camera. To the contrary, the person who installs the cameras is able to grasp how to adjust the position and direction of each of the cameras in order to include a desired part of the entire ball park in the imaging range of the camera. That is, the person who installs the cameras is able to give an appropriate instruction to the cameras by using the terminal.

### (Additional Matter 3)

The display device 200 does not need to include the microphone 270. That is, the display device 200 (transmission processing unit 280) may be configured to be able to acquire, via a cable or wireless communication, data of sound collected by an external microphone (a microphone that the viewer wears).

Similarly, the display device 200 does not need to include the speaker 260. That is, the display device 200 (sound output processing unit 240) may output, from an external speaker (for example, an earphone that the viewer wears), sound of the program and sound collected by the camera 300.

### (Additional Matter 4)

Every time an operation (for example, a channel switching operation) of changing a program is performed, the display device 200 may determine whether or not distribution data indicating content of a program after the change includes URL information indicating an acquisition destination of a video (a video in a lower part of which an audience appears) different from a program video. Only when determining that the distribution data includes the URL information, the display device 200 may perform the following processing.

That is, the display device 200 may acquire the different video (for example, a video indicating a state of cheering seats of the baseball park) from a camera (for example, the camera 300) as the acquisition destination of the different video by referring to the URL information.

### Embodiment 2

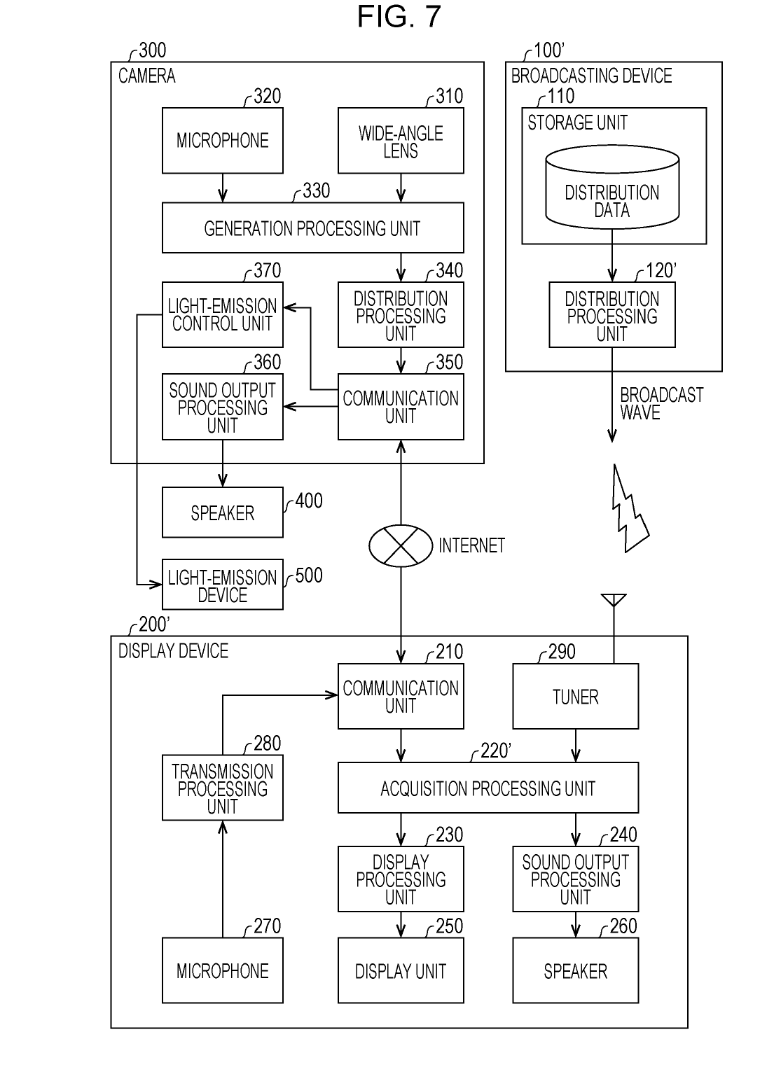

Devices of a broadcasting device, a display device, and a camera that are included in a system according to another embodiment of the invention will be described in detail with further reference to FIG. 7. FIG. 7 is a block diagram illustrating a configuration of a main part of each of main devices included in the system. Note that, for convenience of description, members having the same functions as those of the members described in Embodiment 1 are given the same reference signs and the description thereof will be omitted.

### (Outlines and Configurations of Devices)

Outlines and configurations of the main devices included in the system will be described with reference to FIG. 7.

As illustrated in FIG. 7, the system according to the present embodiment is a system that includes a broadcasting device 100′, a display device 200′, and the camera 300.

The broadcasting device 100′ is a broadcasting device that distributes distribution data indicating content of a broadcasting program (a baseball broadcasting program in the present embodiment) (that is, indicating a video and sound of the broadcasting program).

The display device 200′ is a television receiver that receives a broadcast signal (broadcast wave) including the distribution data indicating the video and the sound of the broadcasting program and reproduces the broadcasting program.

### (Broadcasting Device 100′)

As illustrated in FIG. 7, the broadcasting device 100′ includes the storage unit 110 and a distribution processing unit 120′.

The distribution processing unit 120′ transmits the broadcast signal (broadcast wave) including the distribution data.

### (Display Device 200′)

As illustrated in FIG. 7, the display device 200′ includes the communication unit 210, an acquisition processing unit 220′, the display processing unit 230, the sound output processing unit 240, the display unit 250, the speaker 260, the microphone 270, the transmission processing unit 280, and a tuner 290.

The acquisition processing unit 220′ acquires the video of the broadcasting program through reception of the broadcast wave and acquires, via the Internet, a different video generated by the camera 300.

That is, the acquisition processing unit 220′ receives the distribution data that includes URL information (acquisition destination information indicating an acquisition destination of the different video) and video data and sound data of the broadcasting program, and thereby acquires the video of the broadcasting program together with the URL information. The acquisition processing unit 220′ is connected to the camera 300 as the acquisition destination of the different video by referring to the URL information included in the distribution data and acquires the different video from the camera 300.

The tuner 290 is a known general tuner device.

### (Operation of Display Device 200′)

Next, an operation of the display device 200′ after an operation of reproducing the baseball broadcasting program is received will be described with reference to FIG. 3 again. Note that, examples of the operation of reproducing the baseball broadcasting program in the present example include the following operations.

an operation of turning on power of the display device 200′ in a case where a channel on which the baseball broadcasting program is broadcasted is the last channel

an operation of pressing a button of the channel, on which the baseball broadcasting program is broadcasted, of a remote controller

The display device 200′ having received the aforementioned operation carries out the operation based on the flowchart of FIG. 3 in a similar manner to that of the display device 200 according to Embodiment 1.

However, specific processing executed at S1 by the display device 200′ is different from specific processing executed at S1 by the display device 200 in the following point.

That is, the acquisition processing unit 220′ starts to acquire the distribution data of baseball broadcasting, which is distributed by the broadcasting device 100′, by performing processing for selecting a broadcast station that broadcasts the baseball broadcasting.

### Embodiment 3

A system according to still another embodiment of the invention will be described.

The system according to the present embodiment is different from the system according to Embodiment 1 in the following point.

That is, a display device according to the present embodiment displays a video generated by the camera 300 (for example, the camera 300 behind the outfield seats behind the first base) only during a period when a target team (for example, a team whose player is in dugout behind the first base) corresponding to a UI button (for example, a UI button corresponding to the outfield seats behind the first base) selected by the viewer is at bat.

During a period when the target team is in the field, the display device according to the present embodiment displays a screen for a communication tool in an area in which the video from the camera 300 is displayed during a period when the target team is at bat. An example of the communication tool includes a chat application (e.g. LINE) such as avatar chat.

The communication tool is a tool for the viewer viewing the baseball broadcasting program to communicate with spectators (for example, spectators around the camera 300) who are in the baseball park (broadcast spot).

Note that, the display device according to the present embodiment may be configured to recognize an at-bat period and an in-field period of the target team by the following method.

That is, the display device may analyze the video generated by the camera 300, which corresponds to the UI button selected by the viewer, to thereby periodically specify magnitude of motion of spectators (spectators near the camera 300) appearing in a lower part of the video. The display device may recognize timing when the motion suddenly becomes large as a starting time of the at-bat period (a finish time of the in-field period) and recognize timing when the motion suddenly becomes small as a starting time of the in-field period (a finish time of the at-bat period).

### Other Embodiments

A display device according to an embodiment of the invention may extract only an image of a human being (a spectator visiting the baseball park) from the aforementioned video, further extract a strenuously moving part (for example, an image of a strenuously moving arm, an entire image of a jumping human being, or the like) in the extracted image of the human being, and display only the strenuously moving part that is extracted.

A display device according to an embodiment of the invention may be configured to recognize a face image of a human being in the video. The display device may perform, for the video, blurring processing for blurring the recognized face image which is larger than a predetermined size, and then display the video subjected to the blurring processing.

Alternatively, when having recognized the face image which is larger than the predetermined size, the display device may perform blurring processing for the entire video and then display the video subjected to the blurring processing.

### (Additional Matter 1)

A plurality of site devices may be installed in the vicinity of each of the outfield seats behind the first base and the outfield seats behind the third base. For example, a certain site device may be installed behind the outfield seats behind the first base and a different site device may be installed on a pole of an outfield fence behind the first base. Specifically, the certain site device may be placed so that the wide-angle lens 310 is directed to the outfield seats behind the first base and the playing field, and the different site device may be placed so that a sound output surface of the speaker 400 and a sound acquisition surface (diaphragm surface) of the microphone 320 are directed to the outfield seats behind the first base.

In such a case, the display device 200 may output sound collected by the different site device while displaying a video generated by the certain site device.

Note that, a housing of each of the certain site device and the different site device may be a housing resembling an appearance of a human being. The housing resembling an appearance of a human being may be, for example, a housing resembling an appearance of a human being who wears a uniform of a team whose player is in dugout behind the first base.

The housing resembling the appearance of a human being is desired to be a housing resembling an appearance of a former famous player who belonged in the past to the team whose player is in the dugout behind the first base.

### (Additional Matter 2)

The display device may cause a video from the camera 300 and a broadcasting video to be synchronized with each other. That is, the display device 200 may reproduce the video from the camera 300 and the broadcasting video so that “an image frame of the broadcasting video” generated at any time t and an image frame generated at the time t by the camera 300 are displayed substantially at the same time.

As a result, not only when reproducing a video from the camera 300 that provides poor communication quality with the display device and the broadcasting video but also when reproducing a video from the camera 300 that provides good communication quality with the display device and the broadcasting video, the display device is able to reproduce both of the videos without making the viewer feel uncomfortable.

Note that, an absolute time may be used to cause the video from the camera 300 and the broadcasting video to be synchronized with each other.

### (Additional Matter 2′)

When detecting that data of sound indicating specific content (for example, public address announcement) is acquired from the VOD server 100 at a time t and data of sound having the same content is acquired from the camera 300 at the time t+Δt (time t−Δt), the display device may perform the following synchronous reproduction processing.

That is, the display device may reproduce, at completely or substantially the same time, an image frame acquired from the VOD server 100 at any subsequent time T and an image frame acquired from the camera 300 at the time T+Δt (time T−Δt).

Alternatively, when detecting that the image frame acquired from the VOD server 100 at the time t includes an image of a subject whose appearance changes with lapse of time and the image frame acquired from the camera 300 at the time t+Δt (time t−Δt) includes an image of the subject having the same appearance as that of the aforementioned image, the display device may perform the synchronous reproduction processing described above.

Note that, when the broadcasting program is a baseball broadcasting program, the subject may be, for example, a BSO count display of a scoreboard.

### (Additional Matter 3)

The display device may periodically perform the following measurement processing. That is, for each of the plurality of site devices described above, the display device may measure quality of communication between the display device and the site device.

At timing when obtaining a measurement result indicating that quality of the communication between the display device and a site device that is connected becomes less than a fixed level, the display device may switch the site device as the connection destination to a site device which provides better communication quality with the display device.

Then, the display device may reproduce a video with sound that is distributed by the new site device.

### (Additional Matter 4)

The display device is desired to output sound of a program and sound collected by a site device so that the sound collected by the site device is more remarkable than the sound of the program as illustrated in FIG. 5.

In view of such a point, a plurality of speakers placed to surround the viewer may be connected to the display device. The display device to which the plurality of speakers are connected may reproduce the sound, collected by the site device, in surround.

Alternatively, two speakers (for example, 2.1-channel speakers) may be placed on the right and left of the display device. In this case, the display device to which the two speakers are connected may perform pseudo surround reproduction so that the sound collected by the site device is output from the two speakers.

For example, the display device 200 may reproduce left channel sound so that a sound image of the left channel sound of the broadcasting program is localized at a certain position L1 on the left side of the display device 200 and a sound image of the left channel sound collected by the camera 300 is localized at a different position L2 (a position farther away from the display device 200 than the certain position L1) on the left side of the display device 200.

Similarly, the display device 200 may reproduce right channel sound so that a sound image of the right channel sound of the broadcasting program is localized at a certain position R1 on the right side of the display device 200 and a sound image of the right channel sound collected by the camera 300 is localized at a different position R2 (a position farther away from the display device 200 than the certain position R1) on the right side of the display device 200.

### (Additional Matter 5)

In Embodiment 1, the camera 300 is configured to generate the video indicating the scene (the almost entire state of the area formed by the seats and the playing field of the baseball park) captured by the wide-angle lens 310 and directly distribute the generated video.

However, the camera 300 is not limited to such a configuration.

For example, the camera 300 may process the generated video as follows and then distribute the processed video.

That is, to each of image frames of the generated video, the camera 300 may apply a process of reducing an information quantity of a center or its upper area of the image frame. For example, with respect to each of the image frames, the camera 300 may replace an image in the center or its upper area of the image frame with an image in one color of black.

### (Additional Matter 6)

The display device may include a camera (that is, a camera installed so that the viewer viewing a program is captured in an imaging range) directed in the same direction as a normal direction of a display screen. The display device may use the camera to generate a video indicating a state of the viewer cheering while waving a noisemaker.

The display device may recognize vigorousness of waving the noisemaker (that is, vigorousness of the cheering) by analyzing the generated video and transmit information indicating a level of the vigorousness of waving the noisemaker to the camera 300.

The camera 300 may control light-emission intensity of the LED light-emission device 500 on the basis of the information transmitted from the display device.

Alternatively, the camera 300 may analyze sound data transmitted from many display devices to thereby specify content of cheering common to many viewers. Then, the camera 300 may control the LED light-emission device 500 so that light emission is performed with the light-emission intensity according to the number of the viewers performing the cheering indicating such content.

The display device 200 according to each of Embodiments 1 and 2 is configured to transmit sound data indicating sound of cheering of the viewer to the camera 300; however, the invention is not limited to such a configuration.

For example, with respect to various contents of cheering, the camera 300 may hold a pair of sound data indicating sound (for example, voice of “lets' go”) which indicates the content and text data indicating a character string (for example, a character string of “let's go”) which indicates the content. When detecting voice of cheering of the viewer, the display device 200 may transmit, to the camera 300, cheering data that indicates a sound volume, sound pressure, and/or tone interval of the cheering by a character string or a numerical value and text data indicating the content of the cheering.

The camera 300 having received the cheering data and the text data may determine whether or not sound data that is paired with the received text data is held. When determining that such sound data is held, the camera 300 may reproduce sound of the cheering indicated by the sound data so that sound with a volume according to the cheering data that is received with the text data is output from the speaker 400.

Alternatively, the camera 300 may be connected to an external display device (not illustrated). The camera 300 may specify content indicated by voice uttered by many viewers and determine whether the voice indicates affirmative content or negative content. Then, the camera 300 may display the number of viewers who have uttered the voice indicating the content and the content on the external display device in a display format according to a result of the determination.

Note that, an example of a case where content indicated by voice uttered by many viewers is determined to be negative content includes a case where many viewers boo a player of a team that they like.

### (Additional Matter 7)

With a method according to a form of subscription made between a VOD service operator distributing a program and the viewer, the display device 200 may reproduce a video with sound distributed by the camera 300.

For example, when the subscription is free, the display device 200 may perform reproduction with frame dropping for the video distributed by the camera 300. In addition, when the subscription is free, the display device 200 may reproduce sound distributed by the camera 300 so that the sound is not excessively remarkable.

Alternatively, when the subscription is paid, the display device 200 may display information about a cheering song (such as lyrics) or choreography of cheering (megaphone dance) of the team that the viewer likes.

### (Additional Matter 8)

The camera 300 is desired to be made from a material that is difficult to break even when being hit.

The camera 300 is desired to be installed at a position difficult for spectators to reach. Alternatively, the camera 300 may be a drone.

### (Additional Matter 9)

In each of the embodiments, a baseball broadcasting program is taken as an example of a broadcasting program. Examples of broadcasting programs of other types are as follows.

Broadcasting program of soccer (broadcast spot: soccer ground, attention object of spectators: two matching teams)

Broadcasting program of golf (broadcast spot: golf course, attention object of spectators: playing players)

Broadcasting program of fireworks (broadcast spot: firework display, attention object of spectators: fireworks)

Broadcasting program of musical (broadcast spot: theater, attention object of spectators: troupe members)

Broadcasting program of fashion show (broadcast spot: event site, attention object of spectators: models)

Broadcasting program of astronomical show (for example, total eclipse of the moon) (broadcast spot: any place (for example, roof of building) where an astronomical show is able to be enjoyed, attention object of spectators: astronomical object)

Note that, in any case, the camera 300 is placed at a position where the camera 300 is able to capture a video in a lower part of which spectators appear and in a center part or its upper part of which an attention object appears.

### [Implementation Example by Software]

A control block of each of devices of the VOD server 100 (broadcasting device 100′), the display device 200, and the camera 300 (particularly, the distribution processing unit 120 (120′), the acquisition processing unit 220 (220′), the display processing unit 230, the sound output processing unit 240, the transmission processing unit 280, the generation processing unit 330, the distribution processing unit 340, the sound output processing unit 360, and the light-emission control unit 370) may be realized by a logic circuit (hardware) formed in an integrated circuit (IC chip) or the like, or may be realized with software by using a CPU (Central Processing Unit).

In the latter case, each of the devices includes the CPU which executes a command of a program which is software for realizing each function, a ROM (Read Only Memory) or a storage device (each of which is referred to as a “recording medium”) in which the program and various data are recorded so as to be readable by a computer (or the CPU), a RAM (Random Access Memory) which develops the program, and the like. When the computer (or the CPU) reads the program from the recording medium for execution, an object of the invention is achieved. As the recording medium, it is possible to use a “non-transitory tangible medium” such as, for example, a tape, a disk, a card, a semiconductor memory, or a programmable logic circuit. Moreover, the program may be supplied to the computer via any transmission medium (a communication network, a broadcast wave, or the like) by which the program is able to be transmitted. Note that, the invention may be realized also in a form of a data signal in which the program is embodied by electronic transmission and which is embedded in a carrier wave.

### SUMMARY

An information device (display device 200) according to an aspect 1 of the invention includes an acquisition processing unit (acquisition processing unit 220) that individually acquires a video of a broadcasting program (baseball broadcasting program) and a different video in a lower part of which spectators in a broadcast spot (baseball park) appear, and a display processing unit (display processing unit 230) that displays, while displaying the different video on a primary screen, the video of the broadcasting program on a secondary screen with use of a picture-in-picture function, in which the different video is a video generated by a camera (camera 300) in the broadcast spot, and the secondary screen is positioned at a center part or its upper part of the primary screen.

According to the aforementioned configuration, a viewer is able to view the broadcasting program while watching the video in the lower part of which the spectators in the broadcast spot appear. That is, the viewer is able to view the broadcasting program while feeling as if he or she was seeing an attention object together with the spectators behind the spectators in the broadcast spot.

Thus, it may be said that the information device exerts an effect of allowing the viewer to view the broadcasting program while giving realistic sensation as if he or she was actually in the broadcast spot.

Note that, the camera in the broadcast spot may be one of many cameras used for program broadcasting or may be a camera (for example, a camera that is installed in the baseball park by an operator of the baseball park) that is not used for program broadcasting.

In the information device according to an aspect 2 of the invention, the camera may be a camera including a wide-angle lens (wide-angle lens 310) in the aspect 1. Note that, the wide-angle lens is a lens having a wider angle of view (a shorter focal distance) than that of a standard lens, and as a range of the wide-angle lens, not only a general wide-angle lens but also a super wide-angle lens and a fish-eye lens are also included.

In the information device according to an aspect 3 of the invention, the acquisition processing unit may acquire, together with the video of the broadcasting program, acquisition destination information (URL information) indicating an acquisition destination of the different video, and further acquire the different video by referring to the acquisition destination information, in the aspect 1 or 2.

According to the aforementioned configuration, an effect is further exerted that even if the acquisition destination of the different video is changed, when the acquisition destination information that is acquired together with the video of the broadcast spot is changed, the information device is able to acquire the different video without causing a user to perform a particular operation.

In the information device according to an aspect 4 of the invention, the camera may include a microphone (microphone 320), the different video may be a video with sound captured by the microphone, and a sound output processing unit (sound output processing unit 240) that outputs the sound captured by the microphone while outputting sound of the broadcasting program may be included, in any of the aspects 1 to 3.

According to the aforementioned configuration, as the viewer views the broadcasting program while listening to the sound (voices of people near the camera) captured by the microphone, the viewer is able to view the broadcasting program while feeling as if he or she was actually visiting the broadcast spot (as if he or she was near the people).

That is, the information device further exerts an effect of enabling further enhancement of realistic sensation that the viewer experiences.

In the information device according to an aspect 5 of the invention, the broadcast spot may be a baseball park and the camera is a camera installed behind the outfield of the baseball park, in any of the aspects 1 to 4.

According to the aforementioned configuration, the information further exerts an effect of allowing the viewer to view the broadcasting program while feeling as if he or she actually watched a game in the baseball park.

A display processing method according to an aspect 6 of the invention is a display processing method by an information device, and the display processing method includes the steps of individually acquiring a video of a broadcasting program and a different video in a lower part of which spectators in a broadcast spot appear; and displaying, while displaying the different video on a primary screen, the video of the broadcasting program on a secondary screen with use of a picture-in-picture function, in which the different video is a video generated by a camera in the broadcast spot, and the secondary screen is positioned at a center part or its upper part of the primary screen.

According to the aforementioned configuration, the display processing method exerts a similar effect to that of the information device according to the aspect 1.

The information device according to each of the aspects of the invention may be realized by a computer, and, in this case, a control program (the program according to the aspect 7 of the invention) of the information device, which causes the computer to operate as the respective units (software elements) provided in the information device to thereby realize the information device in the computer, and a computer readable recording medium which stores the control program therein are also included in the scope of the invention.

The invention is not limited to each of the embodiments described above, and may be modified in various manners within the scope of the claims and an embodiment achieved by appropriately combining technical means disclosed in each of different embodiments is also encompassed in the technical scope of the invention. Further, by combining the technical means disclosed in each of the embodiments, a new technical feature may be formed.

### REFERENCE SIGNS LIST

200 display device (information device)
220 acquisition processing unit
230 display processing unit
240 sound output processing unit
300 camera
310 wide-angle lens
320 microphone

1. An information device comprising:
an acquisition processing unit that individually acquires a video of a broadcasting program and a different video in a lower part of which spectators in a broadcast spot appear; and
a display processing unit that displays, while displaying the different video on a primary screen, the video of the broadcasting program on a secondary screen with use of a picture-in-picture function, wherein
the different video is a video generated by a camera in the broadcast spot, and
the secondary screen is positioned at a center part or an upper part thereof of the primary screen.

2. The information device according to claim 1, wherein the camera is a camera including a wide-angle lens.

3. The information device according to claim 1, wherein the acquisition processing unit acquires, together with the video of the broadcasting program, acquisition destination information indicating an acquisition destination of the different video, and further acquires the different video by referring to the acquisition destination information.

4. The information device according to claim 1, further comprising a sound output processing unit that outputs sound captured by a microphone while outputting sound of the broadcasting program, wherein
the camera includes the microphone, and
the different video is a video with the sound captured by the microphone.

5. A display processing method by an information device, the display processing method comprising the steps of:
individually acquiring a video of a broadcasting program and a different video in a lower part of which spectators in a broadcast spot appear; and
displaying, while displaying the different video on a primary screen, the video of the broadcasting program on a secondary screen with use of a picture-in-picture function, wherein
the different video is a video generated by a camera in the broadcast spot, and
the secondary screen is positioned at a center part or an upper part thereof of the primary screen.
